(19) United States
(12) Patent Application Publication
(10) Pub. No.: US 2005/0228782 A1
(43) Pub. Date: Oct. 13, 2005

(54) Authenticating a web site with user-provided indicators

(76) Inventors: Alexandre Bronstein, Palo Alto, CA (US); Mickey C. Suen, Palo Alto, CA (US)

Correspondence Address: Paul Horstmann, 706 Tenth Street, Hermosa Beach, CA, 90254, US

(21) Appl. No.: 10/819,613

(22) Filed: Apr. 7, 2004

(51) Int. Cl. G06F 7/00

(52) U.S. Cl. 707/3

(57) ABSTRACT

Techniques for authenticating a web site that protect a user from a forged/spoofed web site. A web site according to the present techniques obtains from the user an indicator to be used in authenticating the web site to the user. In response to a request to access the web site, the web site generates a web page that includes the indicator. Recognition of the indicator provides the user with assurance of the authenticity of the web page before entering any personal information, e.g. login name, password, etc. into a web site.

### BACKGROUND

Web sites may be used to provide a wide variety of services to users including financial services, retail services, and information services, to name just a few examples. A web site may include one or more web servers that generate web pages that enable a user to access the services of the web site from a web browser. For example, a web site may generate web pages that enable a user to create accounts, login to accounts, obtain information, perform transactions, etc.

A user may access a web site by requesting web pages from the web site via a web browser. For example, a user may request a login page of a web site of an on-line retailer by entering a web address for the login page into a web browser or by selecting a hyperlink to the login page in another web page or email message. In response, the web site provides the login page to the web browser and the web browser renders the login page to the user.

An unscrupulous party may forge/spoof a web site in an attempt to mislead a user and/or obtain valuable information from a user. For example, an unscrupulous party may forge a web page that purports to be a login page of an online bank's web site. A user may be misdirected into accessing the forged login page and entering their login information e.g. a user name and password, into the forged login page. An unscrupulous party may then use the user name and password obtained via the forged login page to access the victim user's account via the authentic login page of the online bank's web site. Such illegal access may be used, for example, to transfer/steal funds from the victim user.

### SUMMARY OF THE INVENTION

Techniques for authenticating a web site are disclosed that protect a user from a forged/spoofed web site. A web site according to the present techniques obtains from the user an indicator to be used in authenticating the web site to the user. In response to a request to access the web site, the web site generates a web page that includes the indicator. Recognition of the indicator provides the user with assurance of the authenticity of the web page before entering any personal information, e.g. login name, password, etc. into a web site.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a method for authenticating a web site according to the present techniques;

FIG. 2 shows one example of a web page that may be generated by a web site to obtain a UPAI from a user;

FIG. 3 shows one example of a web page that includes a UPAI;

FIG. 4 shows another method for authenticating a web site according to the present techniques;

FIG. 5 shows an embodiment of a web access device that includes a browser application that handles UPAIs in cookies;

FIG. 6 shows an embodiment of a web access device with additional mechanisms for handling UPAIs.

### DETAILED DESCRIPTION

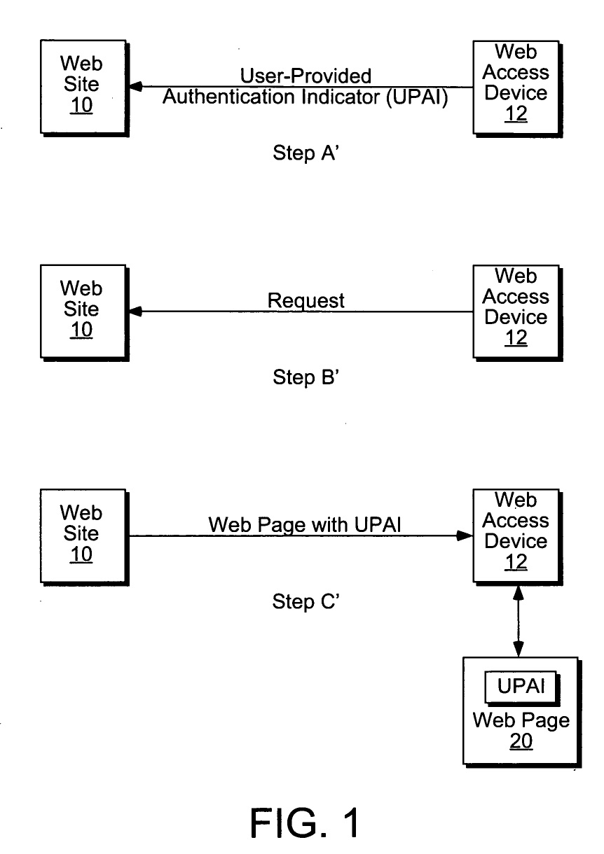

FIG. 1 shows a method for authenticating a web site 10 according to the present techniques.

At step A′, the web site 10 obtains from a user of a web access device 12 an indicator to be used in authenticating the web site 10. The indicator obtained may be referred to as a user-provided authentication indicator (UPAI). The UPAI may be a sentence, e.g. a character string representing a sentence typed by the user of the web access device 12, or a digitized audio sample of a sentence spoken by the user of the web access device 12, or an audio sample or an image sample, e.g. a picture or other image provided by the user of the web access device 12 to name a few examples. Step A′ may be performed when a user creates an account with the web site 10.

The user of the web access device 12 may select the UPAI so that it is relatively individualized and unlikely to be guessed by others. For example, the sentence “I had a great time in the Italian Alps last summer” would be individually meaningful and recognizable to a user having visited the Italian Alps last summer whereas the sentence “The Earth is round” would be much less individually meaningful. A recording of a user's own voice or a picture of their home or child are other examples of an individually meaningful and recognizable UPAI.

A UPAI that is individually meaningful and uniquely recognizable by the user of the web access device 12 may relieve the user from the task of memorizing the UPAI. For example, a UPAI that is a picture or sound of a user's child or an individualized sentence may be immediately recognizable to the user whereas a picture of a landmark or the sentence “The Earth is round” may require that the user memorize the UPAI. The memorization task increases with the number of web site accounts held by the user if non-individualized UPAIs are employed.

Later at step B′, the web access device 12 generates a request to access the web site 10. For example, the user of the web access device 12 may enter a web address into the web access device 12 or select a hyperlink in a web page or email message currently being rendered by the web access device 12. In response, the web access device 12 sends an HTTP request to the web site 10.

At step C′, in response to the HTTP request from the web access device 12, the web site 10 generates a web page 20 that includes the UPAI provided by the user at step A′. The web access device 12 obtains the web page 20 including the UPAI from the web site 10 and renders the web page 20 to the user. Recognition by the user of the web access device 12 of their own user-provided indicator in the web page 20 authenticates the web page 20 to the user as originating with the web site 10.

The UPAI once selected by the user may be stored in a cookie on the web access device 12 or may be stored in a file on the web access device 12 or may be stored on a removable device of the web access device 12 or may be stored in a local data store at the web site 10. The web site 10 retrieves the stored UPAI when generating the web page at step C′.

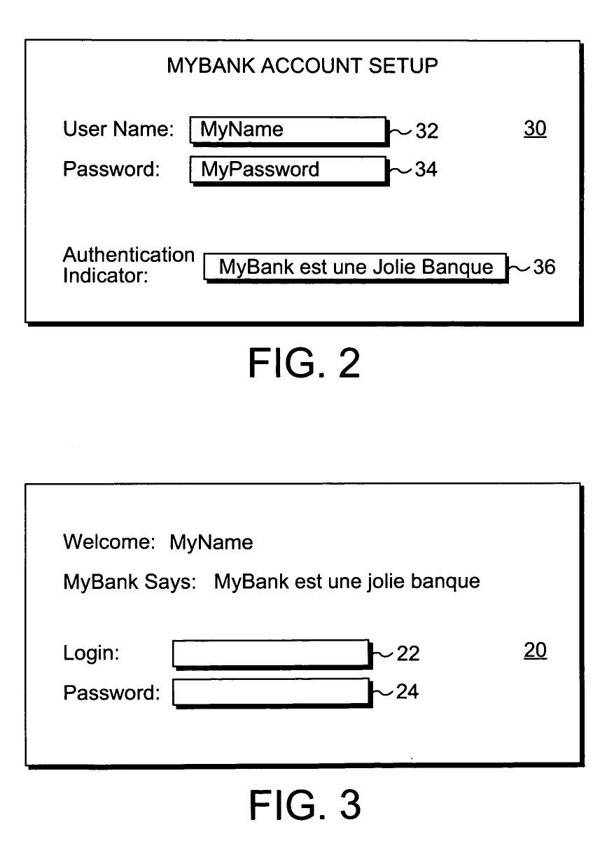

FIG. 2 shows one example of a web page 30 that may be generated at step A′ by the web site 10 to obtain a UPAI from a user of the web access device 12. In this example, the web site 10 belongs to an online bank MYBANK. The web site 10 transfers the web page 30 to the web access device 12 when the user of the web access device 12 selects a MYBANK ACCOUNT SETUP page of the web site 10.

The web page 30 includes a pair of fields 32-34 that enable the user of the web access device 12 to enter a login name and a password for an account with MYBANK. The web page 30 includes a field 36 that enables the user of the web access device 12 to enter an authentication indicator, i.e. a UPAI, to be used for authenticating web pages from the web site 10 at step C′.

FIG. 3 shows one example of the web page 20 generated at step C′ by the web site 10. The web page 20 includes the UPAI provided by the user of the web access device 12 at step A′. The web page 20 also includes a pair of fields 22-24 that enable the user of the web access device 12 to enter a login name and a password to access their account with MYBANK. If the user recognizes the UPAI “MYBank est une jolie banque” in the web page 20 rendered on the web access device 12 then it may be concluded that the web page 20 originated with the MYBANK web site and was not forged by some other entity attempting to impersonate MYBANK.

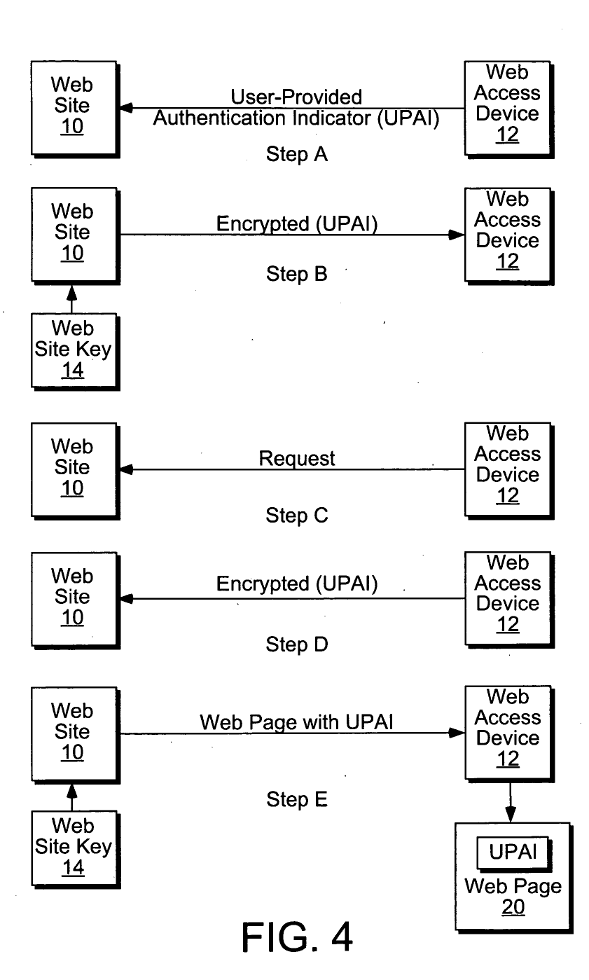

FIG. 4 shows another method for authenticating the web site 10 according to the present techniques. This method employs data security techniques to prevent theft of a UPAI.

At step A, the web site 10 obtains a UPAI from the user of the web access device 12. In one embodiment, the web site 10 generates an account setup web page that is accessible via the web access device 12 and that includes one or more fields that enable the user of the web access device 12 to enter or otherwise specify a UPAI. The web site 10 and the web access device 12 may communicate at step A using https secure protocol to prevent unauthorized parties from obtaining the UPAI.

At step B, the web site 10 encrypts the UPAI obtained at step A and stores an encrypted version of the UPAI, encrypted(UPAI), so that it is accessible by the web site 10 and is associated with the user of the web access device 12. In one embodiment, the encrypted(UPAI) is stored on the web access device 12. The encrypted(UPAI) may be stored on the web access device 12 in a browser managed file, e.g. a cookie, or in a file managed by a UPAI access task on web access device 12 or on a removable device of the web access device 12, e.g. a USB key or magnetic card.

Alternatively, the encrypted(UPAI) may be stored in a data store on the web site 10. The data store also associates to the encrypted(UPAI) a user identifier assigned by the web site 10 to the user of the web access device 12. The user identifier may be kept in a cookie on the web access device 12.

The web site 10 generates the encrypted(UPAI) by combining the UPAI obtained at step A with a web site key 14. Known encryption techniques may be employed at step B. The web site key 14 is securely maintained by the web site 10 to prevent unscrupulous parties from obtaining the web site key 14 and recovering the UPAI.

At step C, a user of the web access device 12 accesses the web site 10. For example, the user may enter a web address into the web access device 12 or select a hyperlink in a web page or email message currently being rendered by the web access device 12. Step C causes the web access device 12 to send an access request, e.g. an HTTP request, to the web site 10.

At step D, the web site 10 obtains the encrypted(UPAI) that was stored at step B. In an embodiment in which the encrypted(UPAI) is stored as a cookie, the web site 10 obtains the encrypted(UPAI) from the web access device 12 as a parameter along with the access request to the web site 10 generated at step C. In an embodiment in which the encrypted(UPAI) is stored in a file or a removable device on the web access device 12, the web site 10 obtains the encrypted(UPAI) from the UPAI access task on the web access device 12. In an embodiment in which encrypted(UPAI) is stored in a data store in the web site 10, the user identifier is received from the web access device 12 as a parameter along with the access request to the web site 10 generated at step C and the web site 10 uses the user identifier to index the data store of the web site 10 and obtain the corresponding encrypted(UPAI).

At step E, the web site 10 recovers the UPAI originally provided by the user at step A by decrypting the encrypted(UPAI) retrieved at step D using the web site key 14. The web site 10 then generates the web page 20 that includes the recovered UPAI. The web site 10 sends the web page 20 to the web access device 12 to complete the access request from step C and the web access device 12 renders the web page 20 to the user of the web access device 12. Recognition by the user of the web access device 12 of their own user-provided indicator in the web page 20 authenticates the web page 20 to the user as originating with the web site 10. A forger would not possess the decryption key needed to recover the UPAI from the encrypted(UPAI).

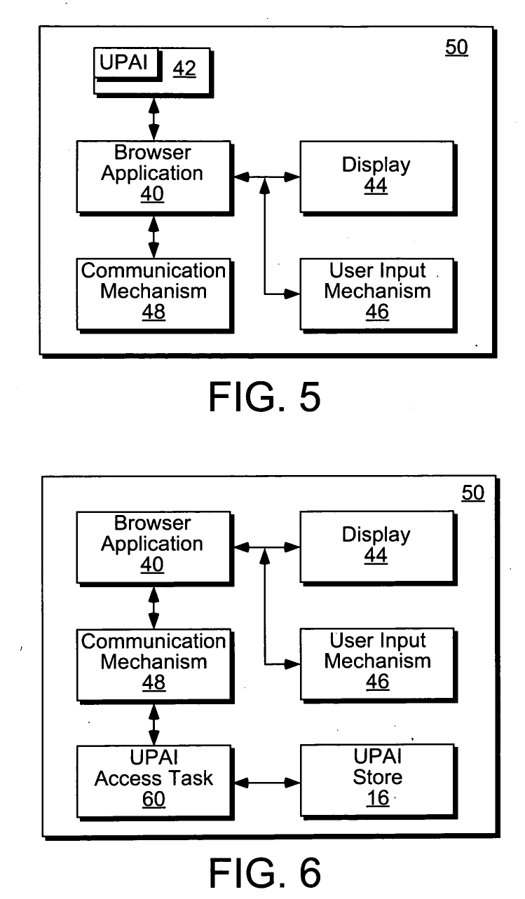

FIG. 5 shows an embodiment of the web access device 12 which is implemented in a processing platform 50, e.g. a desktop computer, a laptop computer, a PDA or other handheld device, etc. The processing platform 50 executes a browser application 40 that is capable of handling a set of cookies 42 using web protocols, including cookies that carry a UPAI or an encrypted(UPAI). The processing platform 50 includes a display 44 for rendering web pages to a user and a user input mechanism 46, e.g. keyboard, for obtaining inputs from a user. The processing platform 50 includes a communication mechanism 48 for communicating with the web site 10 using Internet protocols.

FIG. 6 shows another embodiment of the web access device 12 which is implemented in the processing platform 50 with additional mechanisms for handling UPAIs. In this embodiment, the processing platform 50 includes a UPAI access task 60 that stores UPAIs or encrypted(UPAIs) in a UPAI store 16. The UPAI access task 60 retrieves UPAIs or encrypted(UPAIs) from the UPAI store 16 and provides them to the web site 10.

The UPAI access task 60 may be downloaded from the web site 10 to the processing platform 50 when the user of the web access device 12 creates an account with the web site 10. The UPAI access task 60 once installed and running on the processing platform 50 obtains the UPAI after step A′ or the encrypted(UPAI) at step B from the web site 10 along with a web site identifier (WS_ID) for the web site 10 and stores them in the UPAI store 16. For example, the UPAI access task 60 may use an HTTP command to obtain the WS_ID, encrypted(UPAI) data pair from the web site 10. The UPAI store 16 may be a file in persistent memory, e.g. on disk, of the processing platform 50. The UPAI store 16 may be implemented in a removable device. Examples include removable and transportable storage devices, e.g. USB key, magnetic card, etc.

Table 1 shows example contents of the UPAI store 16. The UPAI store 16 in this example includes a WS_ID, encrypted(UPAI) data pair for each web site account held by the user of the web access device 12. For example, the MyBank, 46f4c430e6e65c2436a8f43ca3 data pair corresponds to the above example for the web site 10.

TABLE 1

| WS_ID | encrypted (UPAI) |
|---|---|
| MyBank | 46f4c430e6e65c2436a8f43ca3 |
| MyOtherBank | 92a6f4de27a8f6e2e36ab7c5c2 |
| RetailerA | d6c4a55ce72ad34fc4e2190f0d |

In one embodiment, the UPAI access task 60 is a background task that monitors the web pages obtained by the browser application 40. The UPAI access task 60 detects an access to a web page on the web site 10 at step B′ or C. For example, the web access device 12 may send an HTTP GET command to the web site 10 at step B′ or C and the web site 10 in response sends a web page to the browser application 40 that includes a tag that causes the UPAI access task 60 to read an entry from the UPAI store 16 and send the information from the entry back to the web site 10 using, for example, an HTTP POST. The tag in the web page may be a non-visible content in the web page that specifies a WS_ID to be used in performing a lookup to the UPAI store 16. For example, a tag in a web page from the web site 10 that includes the WS_ID=MyBank would cause the UPAI access task 60 to read the MYBank entry of the UPAI store 16 and post encrypted(UPAI)=46f4c430e6e65c2436a8f43ca3 to the web site 10. The web site 10 decrypts the obtained encrypted(UPAI) and then generates the web page 20 including the recovered UPAI for display to the user of the browser application 40 at step E.

The processing platform 50 includes the appropriate hardware/software mechanisms to support particular embodiments. For example, if the UPAI store 16 is contained on a removable storage device then the processing platform 50 includes the appropriate hardware and software for accessing the removable storage device, e.g. hardware/software interfaces to a USB key, magnetic card, etc. The processing platform 50 may include the appropriate hardware/software mechanisms to capture and display pictures and/or record/playback sounds, etc., to support different types of UPAIs. For example, the processing platform 50 may include a camera, a microphone, display, speaker and/or drawing programs that enable a user to design a UPAI, etc., as appropriate to particular embodiments.

The web site 10 may include one or more web servers with hardware/software mechanisms for communicating using Internet protocols that enable receipt of access requests from the web access device 12, generation of web pages and transfer of web pages to the web access device 12, cookie handling, and downloading of the UPAI access task 60 to the web access device 12 depending on the embodiment. The web site 10 may include other machines that implement code for performing the present techniques. The web site 10 may include a local data store, e.g. database, for storing UPAIs, or encrypted(UPAIs) along with corresponding user identifiers. The web site key 14 is kept securely away from unauthorized accesses, e.g. in a secure store such as on a secure machine in the web site 10 that is not accessible by potential hackers. The web site key 14 may be used to encrypt the UPAIs for all of the users of the web site 10.

The foregoing detailed description of the present invention is provided for the purposes of illustration and is not intended to be exhaustive or to limit the invention to the precise embodiment disclosed. Accordingly, the scope of the present invention is defined by the appended claims.

1. A method for authenticating a web site, comprising the steps of:
obtaining from a user an indicator to be used in authenticating the web site;
generating a web page that includes the indicator in response to a request to access the web site.

2. The method of claim 1, wherein the indicator is selected by the user to be recognizable to the user.

3. The method of claim 1, wherein the indicator is a character string provided by the user.

4. The method of claim 1, wherein the indicator is a sound.

5. The method of claim 1, wherein the indicator is a picture.

6. The method of claim 1, further comprising the step of storing the indicator in a cookie.

7. The method of claim 6, wherein the step of storing the indicator includes the step of storing an encrypted version of the indicator in the cookie.

8. The method of claim 1, further comprising the step of storing the indicator in a file on a processing platform of the user.

9. The method of claim 8, wherein the step of storing the indicator includes the step of storing an encrypted version of the indicator in the file.

10. The method of claim 1, further comprising the step of storing the indicator in a removable store of a processing platform of the user.

11. The method of claim 10, wherein the step of storing the indicator includes the step of storing an encrypted version of the indicator in the removable store.

12. The method of claim 1, further comprising the step of storing the indicator in a local data store of the web site.

13. A web site, comprising:
means for obtaining from a user an indicator to be used in authenticating the web site;
means for generating a web page that includes the indicator in response to a request to access the web site.

14. The web site of claim 13, further comprising a web site key for encrypting the indicator.

15. The web site of claim 14, further comprising a secure store for the web site key.

16. The web site of claim 13, further comprising a data store for storing the indicator along with an identifier for the user.

17. The web site of claim 13, further comprising means for storing the indicator in a cookie.

18. The web site of claim 13, further comprising means for storing an encrypted version of the indicator in a cookie.

19. The web site of claim 13, further comprising means for downloading a UPAI access task to a web access device employed by the user.

20. The web site of claim 19, further comprising means for generating a web page that includes a tag in response to the request such that the tag causes the UPAI access task to retrieve the identifier from storage on the web access device.

21. A computer-readable storage medium that holds a computer program that when executed authenticates a web site by:
obtaining from a user an indicator to be used in authenticating the web site;
generating a web page that includes the indicator in response to a request to access the web site.

22. The computer-readable storage medium of claim 21, wherein the indicator is a character string provided by the user.

23. The computer-readable storage medium of claim 21, wherein the indicator is a sound.

24. The computer-readable storage medium of claim 21, wherein the indicator is a picture.

25. The computer-readable storage medium of claim 21, further comprising storing the indicator in a cookie.

26. The computer-readable storage medium of claim 25, wherein storing the indicator includes storing an encrypted version of the indicator in the cookie.

27. The computer-readable storage medium of claim 21, further comprising storing the indicator in a file on a processing platform of the user.

28. The computer-readable storage medium of claim 27, wherein storing the indicator includes storing an encrypted version of the indicator in the file.

29. The computer-readable storage medium of claim 21, further comprising storing the indicator in a removable store of a processing platform of the user.

30. The computer-readable storage medium of claim 29, wherein storing the indicator includes the step of storing an encrypted version of the indicator in the removable store.

31. The computer-readable storage medium of claim 21, further comprising storing the indicator in a local data store of the web site.
